(19) United States
(12) Patent Application Publication
(10) Pub. No.: US 2018/0146107 A1
(43) Pub. Date: May 24, 2018

(54) MOBILE DEVICE, IMAGE FORMING SYSTEM, AND METHOD FOR CONTROLLING MOBILE DEVICE

(71) Applicant: KYOCERA Document Solutions Inc., Osaka (JP)

(72) Inventor: Keita MIYAMOTO, Osaka (JP)

(73) Assignee: KYOCERA Document Solutions Inc., Osaka (JP)

(21) Appl. No.: 15/793,546

(22) Filed: Oct. 25, 2017

(30) Foreign Application Priority Data
Nov. 18, 2016 (JP) 2016-225133

(51) Int. Cl. H04N 1/00; G01S 1/08; G01C 21/10

(52) U.S. Cl. CPC H04N 1/00888; H04N 1/00352; G01C 21/10; H04N 1/00962; G01S 1/08; H04N 1/0083

(57) ABSTRACT

A mobile device includes an operation section, a storage section, a communication section which receives a position detection signal, and a processor. The processor detects a current position based on the position detection signal. The processor makes a determination on whether to give an image forming apparatus (a determination target apparatus) a return instruction to return from a power saving mode to an active mode. When it is possible to determine that a distance between the determination target apparatus and the mobile device has decreased by a distance equal to or greater than a reference distance while a moving speed of the mobile device is equal to or greater than a reference speed, the processor determines to issue the return instruction.

This application is based upon and claims the benefit of priority from the corresponding Japanese Patent Application No. 2016-225133 filed on Nov. 18, 2016, the entire contents of which are incorporated herein by reference.

### BACKGROUND

The present disclosure relates to a mobile device held by a user. The present disclosure also relates to an image forming system including a mobile device and an image forming apparatus.

When an apparatus is turned on but left unused, power is consumed wastefully. There are cases where the state of power supply to an apparatus is switched depending on the distance between the apparatus and the user. The following is a known example of techniques for preventing an apparatus from being left unused with its power supply on.

Specifically, there has been known an information terminal that detects sound, transmits to an apparatus a signal capable of operating the apparatus, and, in a case where it is found, based on the result of sound detection, that there is no person around the apparatus, transmits to the apparatus a signal to switch the power supply of the apparatus to a standby state or a turned-off state.

An image forming apparatus is generally provided with a power saving mode and an active mode. The power saving mode is also referred to as a sleep mode. The active mode is also referred to as a normal mode or a standby mode. In the active mode, power is supplied to a particular portion of the image forming apparatus. In the power saving mode, power is not supplied to the particular portion. For example, the particular portion includes units that execute jobs such as printing, scanning, etc. This helps reduce power consumption in the image forming apparatus.

There is an image forming apparatus in which power supply to sections and units used for jobs is stopped in the power saving mode. Such an image forming apparatus cannot execute the jobs when it is in the power saving mode. To bring the image forming apparatus back into an operable state, it is necessary to return the image forming apparatus to the active mode. In returning the image forming apparatus to the active mode, power supply to the particular portion is restarted. At the particular portion, the power supply to which has been restarted, a predetermined startup process is performed. A certain length of time is necessary from the start of the mode return until the mode return is completed. The user cannot use the image forming apparatus until it is completely returned to the active mode.

To return the image forming apparatus to the active mode, the user operates the image forming apparatus in a predetermined manner to release the power saving mode. For example, the user operates a key for releasing the power saving mode. The mode return process is started in response to the user's operation on the key. The user cannot immediately make settings for a job or issue an instruction to execute a job. This is disadvantageous in that the user is required to wait from the start until the end of the mode return process. Kept waiting for a long time, some users may be annoyed. Thus, it is desirable to make the waiting time as short as possible. The technique used in the known information terminal described above is a solution for a case where the power supply is left on because the user has forgot to turn it off. The above-described known technique does not help reduce the use's waiting time from the start until the end of the mode return process.

### SUMMARY

According to an aspect of the present disclosure, a mobile device includes an operation section, a storage section, a communication section, and a processor. The operation section accepts a setting. The storage section stores data therein. The communication section receives a position detection signal for obtaining a current position of the mobile device. The processor detects the current position based on the position detection signal. The processor makes a determination on whether to give a determination target apparatus a return instruction to return from a power saving mode to an active mode. The determination target apparatus is an image forming apparatus set as a target of determination. The determination target apparatus is provided with the power saving mode, in which power supply to a power supply restriction portion, which is determined in advance, is restricted, and the active mode in which power is supplied to the power supply restriction portion. The processor determines to issue the return instruction when it is possible to determine, based on a change of the current position, that a separation distance, which is a distance between the determination target apparatus and the mobile device, has decreased by a distance equal to or greater than a reference distance while a moving speed of the mobile device is equal to or greater than a reference speed, the reference distance and the reference speed being determined in advance. The processor, on determining to issue the return instruction, makes the communication section transmit the return instruction.

Further features and advantages of the present disclosure will become apparent from the description of embodiments given below.

### BRIEF DESCRIPTION OF THE DRAWINGS

FIG. 1 is a diagram showing an example of an image forming system according to an embodiment.

FIG. 2 is a diagram showing an example of a mobile device according to the embodiment.

FIG. 3 shows an example of area determination performed by using a beacon signal according to the embodiment.

FIG. 4 is a diagram showing an example of an image forming apparatus according to the embodiment.

FIG. 5 is a diagram for illustrating an example of modes of a determination target apparatus according to the embodiment.

FIG. 6 is a diagram showing an example of contents stored in a storage section of the mobile device according to the embodiment.

FIG. 7 is a diagram showing an example of a determination setting screen according to the embodiment.

FIG. 8 is a flow chart showing an example of a flow of determination by using a beacon signal in the mobile device according to the embodiment.

FIG. 9 is a flow chart showing an example of a flow of determination by using a GPS signal in the mobile device according to the embodiment.

FIG. 10 is a flow chart showing an example of a flow of shift notification made based on a job termination notification in the mobile device according to the embodiment.

FIG. 11 is a flow chart showing an example of a flow of processing performed when the determination target apparatus according to the embodiment receives a return instruction.

FIG. 12 is a flow chart showing an example of a flow of processing performed when the determination target apparatus according to the embodiment receives a shift instruction.

### DETAILED DESCRIPTION

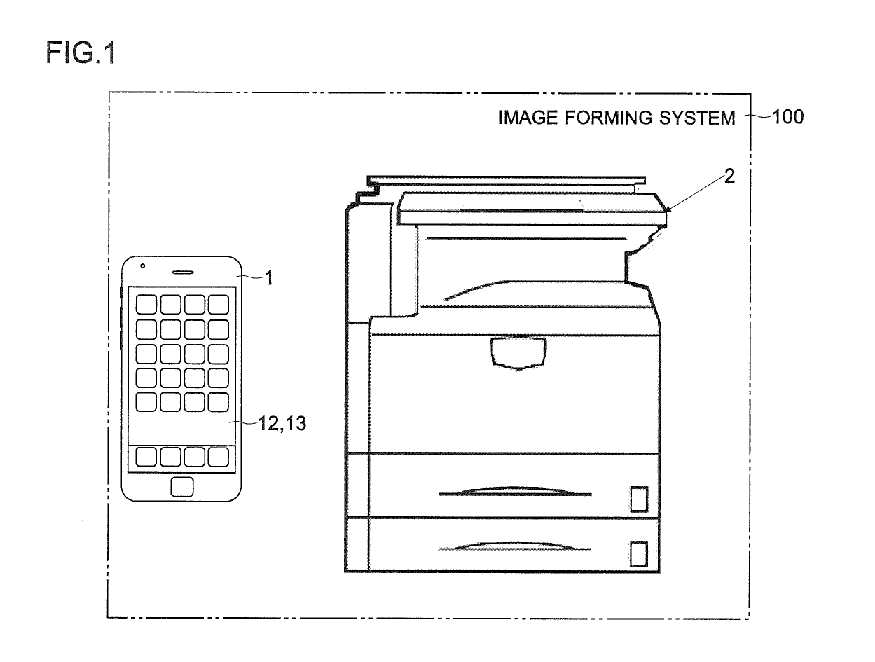

According to the present disclosure, an image forming apparatus is made to start returning to an active mode when the holder of a mobile device is still on his or her way to the image forming apparatus, to thereby reduce waiting time. Hereafter, an embodiment of the present disclosure will be described by using FIGS. 1 to 11. It should be understood, however, that factors such as configurations and arrangements described herein are merely illustrative examples, and are not to be construed as limiting on the present disclosure.

Descriptions will be given below of a mobile device 1 and an image forming system 100 including the mobile device 1 and a determination target apparatus 2. In the descriptions, a smart phone is dealt with as an example of the mobile device 1. The determination target apparatus 2 is an image forming apparatus with respect to which the mobile device 1 makes a determination. The determination target apparatus 2 (the image forming apparatus) is provided with a power saving mode and an active mode. The power saving mode is a mode in which power supply is restricted with respect to a power supply restriction portion, which is determined in advance. The active mode is a mode in which power is supplied to the power supply restriction portion.

Schematic Configuration of Image Forming System 100:

First, based on FIG. 1, a description will be given of an example of the image forming system 100 according to the present embodiment. The image forming system 100 includes a mobile device 1. Users of the determination target apparatus 2 each own and carry a mobile device 1. Hereinafter, a user who holds a mobile device 1 will be referred to as a holder. At least one mobile device 1 is included in the image forming system 100. In FIG. 1, for convenience's sake, just one mobile device 1 is illustrated. The mobile device 1 illustrated in FIG. 1 is a smart phone. The mobile device 1, however, is not limited to a smart phone. The mobile device 1 may also be a notebook computer, a tablet computer, or the like.

The determination target apparatus 2 performs a job. The determination target apparatus 2 is a multifunction peripheral, a printer, or the like, for example. The determination target apparatus 2 is capable of performing printing based on image data of a read document (a copy job). It is also capable of transmitting image data of a document acquired through reading (a transmission job).

Mobile Device 1:

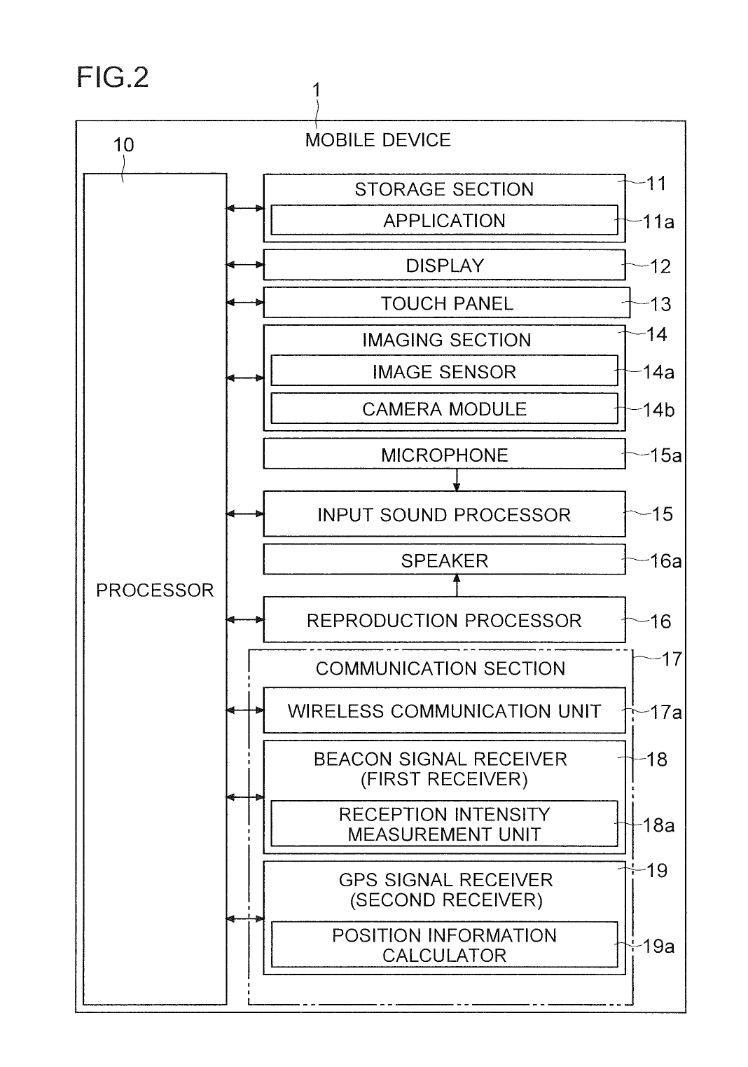

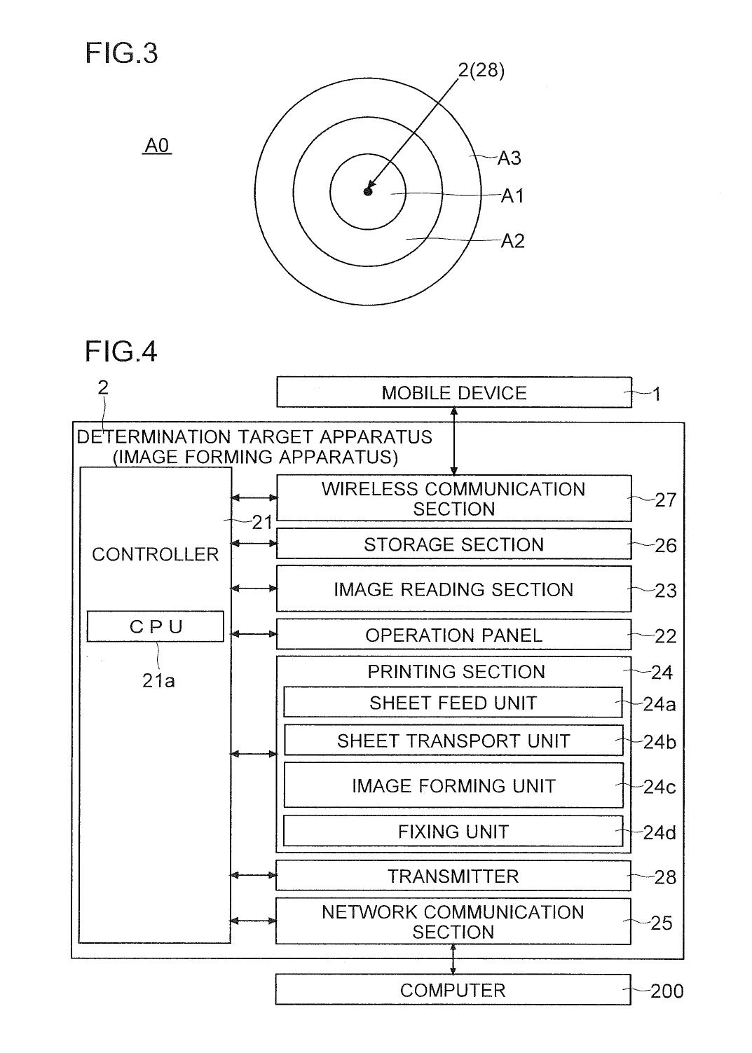

Next, a description will be given, by using FIG. 2 and FIG. 3, of an example of the mobile device 1 according to the embodiment. The mobile device 1 includes a processor 10, a storage section 11, a display 12, a touch panel 13 (corresponding to an operation section), an imaging section 14, a microphone 15a, an input sound processor 15, a speaker 16a, a reproduction processor 16, and a communication section 17. The communication section 17 includes a wireless communication unit 17a, a beacon signal receiver 18 (corresponding to a first receiver), and a GPS signal receiver 19 (corresponding to a second receiver).

The processor 10 is a circuit that controls the operation of the mobile device 1. The processor 10 is an SoC, for example. The storage section 11 includes a ROM, a RAM, and a flash memory. The storage section 11 stores therein a control program, control data, and image data. The storage section 11 also stores therein various applications 11a. The processor 10 controls the operation of the mobile device 1 based on an OS, the program, the applications, and the data stored in the storage section 11 of the mobile device 1.

The display 12 displays an image in accordance with a request from the processor 10. The display 12 is a display panel, such as a liquid crystal display panel or an organic EL display panel. The touch panel 13 (corresponding to the operation section) accepts a setting operation performed by the user. The touch panel 13 is connected to the processor 10. The processor 10 detects a touch position based on an output from the touch panel 13. The processor 10 detects which of operation images has been touched. The display 12 displays the operation images. The operation images are icons, buttons, keys, and tabs, for example. The user can start (use) any of the various applications by operating a corresponding icon. On receiving a request to start an application via the touch panel 13, the processor 10 reads and executes the application stored in the storage section 11.

The imaging section 14 is a camera provided in the mobile device 1. In addition to a lens, the imaging section 14 includes an image sensor 14a and a camera module 14b. The microphone 15a converts an input sound wave (vibration of air) into an electrical signal (an analog signal). For a phone call, the input sound processor 15 converts an output signal of the microphone 15a into a form transmittable from the wireless communication unit 17a. The reproduction processor 16 makes the speaker 16a reproduce voice data of the other party on the phone call received by the wireless communication unit 17a.

The wireless communication unit 17a includes components such as an antenna and a communication circuit. The wireless communication unit 17a is capable of accessing a line according as instructed by the processor 10. The line is a data communication line, a telephone communication line, or the like, which is provided by a mobile network carrier. Via the wireless communication unit 17a, it is possible to transmit and receive data to and from outside, to thereby make a phone call. The wireless communication unit 17a is also capable of performing communication based on a wireless LAN standard.

The beacon signal receiver 18 includes circuits such as an antenna, a communication processing circuit, and a communication memory. The communication memory stores therein data and a program related to beacon communication. The beacon signal receiver 18 receives a beacon signal transmitted from a transmitter 28. The determination target apparatus 2 is provided with the transmitter 28, which transmits the beacon signal (see FIG. 4). The beacon signal is a signal based on a standard such as Bluetooth, Bluetooth Low Energy, Bluetooth Smart, or iBeacon, for example.

The beacon signal receiver 18 includes a reception intensity measurement unit 18a. The reception intensity measurement unit 18a is a circuit that measures the reception intensity (the reception level) of a received beacon signal. The beacon signal receiver 18 is communicably connected to the processor 10. The beacon signal receiver 18 notifies the reception intensity of the beacon signal to the processor 10. The processor 10 detects the reception intensity of the beacon signal.

A first area A1, a second area A2, and a third area A3 are areas centered on the determination target apparatus 2 (the transmitter 28). The first area A1, the second area A2, and the third area A3 are areas where the beacon signal is receivable. The first area A1 is the nearest to the image forming apparatus. The second area A2 is farther from the image forming apparatus than the first area A1 is. The third area A3 is farther from the image forming apparatus than the second area A2 is.

The third area A3 is an area farthest from the image forming apparatus. The second area A2 is located between the first area A1 and the third area A3. The shorter the distance between the mobile device 1 and the transmitter 28 is, the higher the intensity of the received beacon signal becomes. Based on the intensity of the received beacon signal, the processor 10 detects in which of the first area A1, the second area A2, the third area A3, and an outside area A0, which is outside all of the first, second, and third areas A1, A2, and A3, an own device (the mobile device 1) is located. In other words, the processor 10 detects the degree of nearness of the mobile device 1 with respect to the image forming apparatus. In terms of the degree of nearness, the first area A1 is “very near” the image forming apparatus. The second area A2 is “near” the image forming apparatus. The third area A3 is “far” from the image forming apparatus.

FIG. 3 shows an example of a case where these areas are two-dimensionally illustrated in the horizontal direction. In FIG. 3, the circle having the shortest diameter indicates the first area A1. In the first area A1, the black dot indicates the position of the determination target apparatus 2 (the transmitter 28). The second area A2 is an area indicated by the circle having the second longest diameter excluding the first area A1. The third area A2 is an area indicated by the circle having the longest diameter excluding the first and second areas A1 and A2. The area exterior to the third area is an outside area A0.

The GPS signal receiver 19 is also a module that includes circuits such as an antenna, a communication processing circuit, and a communication memory. The communication memory stores therein data and a program related to GPS communication. The GPS signal receiver 19 receives GPS signals transmitted from a plurality of space satellites.

The GPS signal receiver 19 includes a position information calculator 19a. The position information calculator 19a is a circuit that calculates a current position of the own device (the mobile device 1). The position information calculator 19a calculates the current position of the own device based on GPS signals transmitted from different space satellites. The GPS signal receiver 19 is communicably connected to the processor 10. The GPS signal receiver 19 notifies the calculated current position to the processor 10. The processor 10 detects the notified current position of the mobile device 1.

Determination Target Apparatus 2:

Next, by using FIG. 4, a description will be given of the determination target apparatus 2 according to the embodiment. As shown in FIG. 4, the determination target apparatus 2 includes a controller 21, an operation panel 22, an image reading section 23, a printing section 24, a network communication section 25, a storage section 26, a wireless communication section 27, and a transmitter 28.

The controller 21 controls an operation of the determination target apparatus 2. The controller 21 includes a CPU 21a. The storage section 26 is built as a combination of devices such as a ROM, a RAM, and an HDD, for example. The storage section 26 stores therein various kinds of data and a control program. The storage section 26 stores therein data such as control data, setting data, and image data. The CPU 21a controls some sections (the operation panel 22, the image reading section 23, the printing section 24, the network communication section 25, the wireless communication section 27, and the transmitter 28) of the determination target apparatus 2 based on the program and the data stored in the storage section 26.

In jobs such as the copy job, the transmission job, and the like, the controller 21 makes the image reading section 23 read a document. In the document reading operation, the controller 21 makes the image reading section 23 read a document. The image reading section 23 generates image data of the read document. The operation panel 22 accepts an operation performed by the user. The user can make a setting related to a job on the operation panel 22. The user can give an instruction to start execution of a job by inputting the instruction via the operation panel 22. The controller 21 detects the content of the operation performed on the operation panel 22, based on an output signal of the operation panel 22.

The printing section 24 includes a sheet feed unit 24a, a sheet transport unit 24b, an image forming unit 24c, and a fixing unit 24d. In printing, the controller 21 makes the sheet feed unit 24a feed a sheet. The controller 21 makes the sheet transport unit 24b transport the sheet. The controller 21 makes the image forming unit 24c form a toner image based on the image data. The controller 21 makes the image forming unit 24c transfer the toner image onto the transported sheet. The controller 21 makes the fixing unit 24d fix the toner image transferred onto the sheet. The controller 21 makes the sheet transport unit 24b and the fixing unit 24d discharge the sheet, which has gone through the fixing, to the outside of the apparatus.

The network communication section 25 communicates with a computer 200 via a network. The network communication section 25 receives printing data transmitted from the computer 200. The printing data includes image data and data described in a page description language. The controller 21 makes the printing section 24 perform printing based on the received printing data (a print job).

The wireless communication section 27 is a section that transmits and receives data to and from the mobile device 1. The wireless communication section 27 includes a communication processing circuit, a communication memory, an antenna, for example. The wireless communication section 27 is also capable of performing communication based on a wireless LAN standard. The provision of the wireless communication section 27 makes it possible for the mobile device 1 and the determination target apparatus 2 to exchange data with each other.

The transmitter 28 includes circuits such as an antenna, a communication processing circuit, and a communication memory. The communication memory stores therein data and a program related to beacon signal transmission. The transmitter 28 transmits a beacon signal. The transmitter 28 transmits unique ID information i1, which is set in advance. For example, the ID information i1 includes data having an identifier of proximity UUID/Major/Minor. The mobile device 1 identifies, based on the ID information i1 included in the received beacon signal, the image forming apparatus (the determination target apparatus 2, the transmitter 28) that has transmitted the beacon signal.

Modes of Determination Target Apparatus 2:

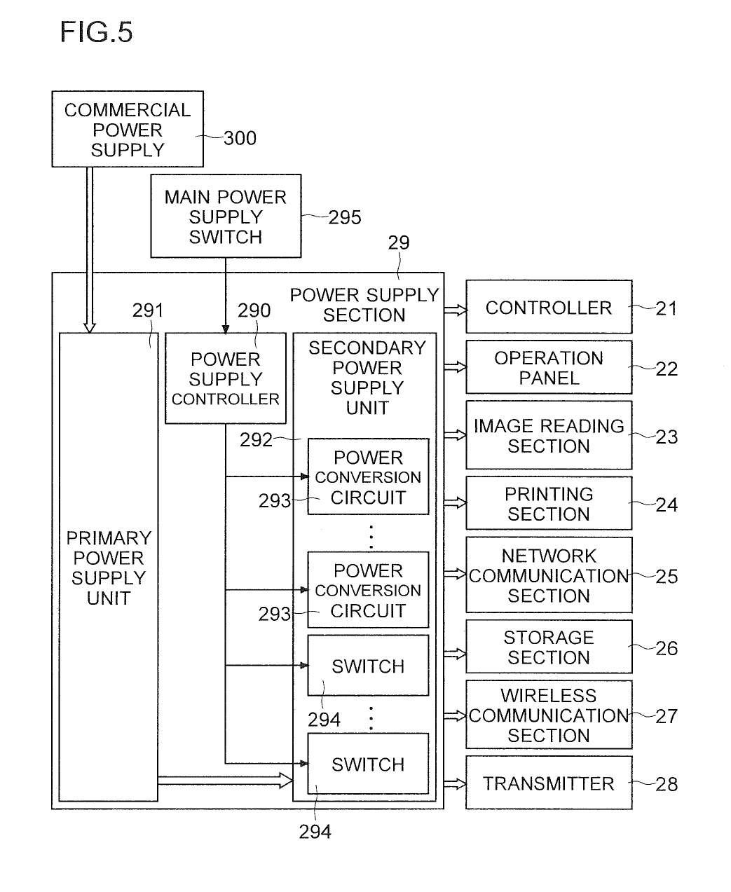

Next, by using FIG. 5, a description will be given of an example of the modes of the determination target apparatus 2 according to the embodiment. As shown in FIG. 5, the determination target apparatus 2 includes a power supply section 29. The power supply section 29 includes a power supply controller 290, a primary power supply unit 291, and a secondary power supply unit 292. The primary power supply unit 291 is connected to a commercial power supply 300 (alternate-current power supply) via a power cord. The primary power supply unit 291 generates a direct-current voltage from the commercial power supply 300. The primary power supply unit 291 generates (outputs) a previously set voltage. For example, the primary power supply unit 291 generates DC24V for driving a motor.

Various circuits and elements are included in the determination target apparatus 2. A plurality of kinds of voltages are necessary to operate the circuits and the elements. Operations of the controller 21, the operation panel 22, the image reading section 23, the printing section 24, the network communication section 25, the storage section 26, the wireless communication section 27, and the transmitter 28 require a plurality of kinds of voltages. To meet this demand, the secondary power supply unit 292 generates a plurality of kinds of direct-current voltages based on the voltage generated by the primary power supply unit 291. To generate the plurality of kinds of voltages, the secondary power supply unit 292 includes a plurality of power conversion circuits 293. The power conversion circuits 293 are each a DC converter or a regulator.

The determination target apparatus 2 has at least a power saving mode and an active mode. The power saving mode is a mode to reduce power consumption of the determination target apparatus 2 in a non-used state (a standby state). In the power saving mode, the power supply section 29 stops (restricts) supplying power to a power supply restriction portion, which is determined in advance. Sections to be included in the power supply restriction portion are determined in advance. In the determination target apparatus 2, part of the controller 21, part of the operation panel 22, the image reading section 23, the printing section 24, and part of the storage section 26 may be included in the power supply restriction portion. The network communication section 25, the wireless communication section 27, and the transmitter 28 are used even in the power saving mode. Hence, in the determination target apparatus 2, the network communication section 25, the wireless communication section 27, and the transmitter 28 are not chosen to be included in the power supply restriction portion.

In the active mode, the power supply section 29 supplies power to all the sections, including the power supply-restriction portion. Thus, in the active mode, the determination target apparatus 2 is able to make settings and execute jobs. For example, a heater of the fixing unit 24d is maintained at a temperature at which fixing is possible. Further, power is supplied to all the sections without restriction. In the active mode, more power is consumed wastefully than in the power saving mode.

Some of the power conversion circuits 293 supply power to both the power supply restriction portion and the sections to which power is supplied even in the power saving mode. Such ones of power conversion circuits 294 are each provided with a switch 294 to turn off the power supply only with respect to the power supply restriction portion. The switch 294 is a switching element such as a transistor. A plurality of switches 294 are provided. The power supply section 29 includes a power supply controller 290. The power supply controller 290 controls ON/OFF of each of the power conversion circuits 293. The power supply controller 290 controls ON/OFF of each of the switches 294.

When a main power supply of the determination target apparatus 2 is turned on, the determination target apparatus 2 begins to start up. The determination target apparatus 2 starts up in the active mode. The determination target apparatus 2 is provided with a main power supply switch 295. The main power supply can be turned ON/OFF by operating the main power supply switch 295.

In shifting from the active mode to the power saving mode, the controller 21 makes the power supply controller 290 stop supplying power to the power supply restriction portion. In returning from the power saving mode to the active mode, the controller 21 makes the power supply controller 290 restart to supply power to the power supply restriction portion. In view of preventing malfunction, power is supplied to the sections of the determination target apparatus 2 in an order, and at timings, set in advance. Also, the power supply to the sections is stopped in an order, and at timings, set in advance. The power supply controller 290 turns on and off the power conversion circuits 293 and the switches 294 in the orders, and at the timings, set in advance.

The user can switch between the modes of the determination target apparatus 2 by operating it. The operation panel 22 includes hardware keys for mode selection. When the operation panel 22 has accepted a mode shifting operation, the controller 21 makes the determination target apparatus 2 shift from the active mode to the power saving mode. When the operation panel 22 has accepted a mode return operation, the controller 21 makes the determination target apparatus 2 return from the power saving mode to the active mode. The controller 21 may automatically switch between the modes when certain conditions are satisfied. For example, the controller 21 may make the determination target apparatus 2 return from the power saving mode to the active mode when the network communication section 25 has received printing data from the computer 200.

Further, the controller 21 makes the determination target apparatus 2 shift between the modes in accordance with instructions from the mobile device 1. The wireless communication unit 17a of the mobile device 1 transmits a mode instruction. The wireless communication section 27 of the determination target apparatus 2 receives the mode instruction. The controller 21 shifts the mode of the determination target apparatus 2 to the instructed mode. The mobile device 1 may use a data line to give mode instructions to the determination target apparatus 2. In such a case, an instruction is conveyed via the following route: the wireless communication unit 17a of the mobile device 1→a line provided by a carrier→a network→the network communication section 25 of the image forming apparatus.

Outline of Determination:

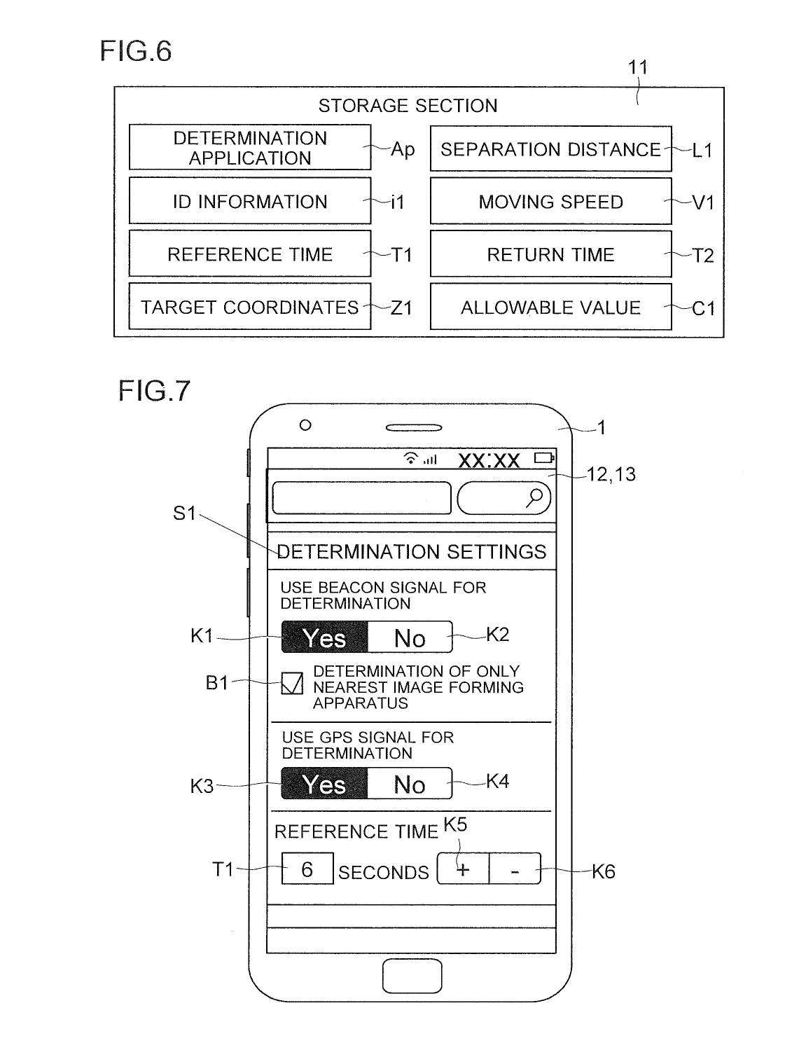

Next, by using FIGS. 6 and 7, a description will be given of the outline of how a determination is made in the mobile device 1 according to the present embodiment. The determination target apparatus 2 (the image forming apparatus) is provided with the power saving mode and the active mode. On the other hand, the communication section 17 of the mobile device 1 includes the beacon signal receiver 18, which receives and processes a beacon signal. The processor 10 is capable of detecting the current position of the own device in relation to the image forming apparatus (a separation distance between the image forming apparatus and the mobile device 1). The communication section 17 of the mobile device 1 includes the GPS signal receiver 19, which receives and processes a GPS signal. That is, the mobile device 1 is capable of obtaining its own current position in relation to the image forming apparatus. Thus, the communication section 17 is capable of receiving a position detection signal for obtaining the current position of the own device in relation to the image forming apparatus.

The processor 10 determines, based on the position detection signal, whether the own device (the mobile device 1) is approaching the determination target apparatus 2. The processor 10 determines, based on the position detection signal, whether the distance between the own device (the mobile device 1) and the determination target apparatus 2 is increasing. Based on results of these determinations, the mobile device 1 gives a return instruction or a shift instruction to the determination target apparatus 2. The return instruction is an instruction for returning the determination target apparatus 2 from the power saving mode to the active mode. The shift instruction is an instruction for shifting the determination target apparatus 2 from the active mode to the power saving mode.

In the storage section 11 of the mobile device 1, there is stored a determination application Ap related to determination. When the determination application Ap is activated, the processor 10 operates based on the determination application Ap. Further, in the determination application Ap, it is possible to set whether to make a determination based on a beacon signal. Further, in the determination application Ap, it is also possible to set whether to make a determination based on a GPS signal.

FIG. 7 shows an example of a determination setting screen S1 displayed on the mobile device 1 based on the determination application Ap. In the determination setting screen S1, a first Yes key K1, a first No key K2, a second Yes key K3, and a second No key K4 are arranged. By means of the first Yes key K1 and the first No key K2, it is possible to set whether to make a determination based on a beacon signal. By means of the second Yes key K3 and the second No key K4, it is possible to set whether to make a determination based on a GPS signal. That is, the mobile device 1 (the touch panel 13) accepts a setting on whether to make a determination based on a beacon signal and a setting on whether to make a determination based on a GPS signal.

Determination Using Beacon Signal:

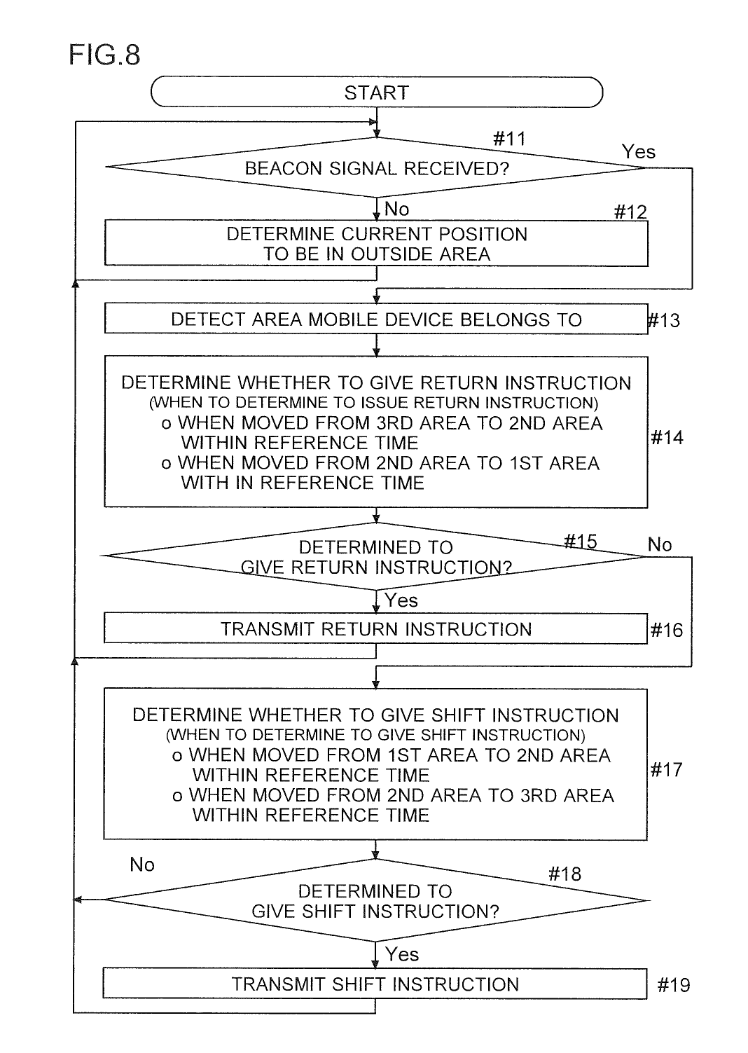

Next, by using FIG. 8, a description will be given of an example of the flow of making a determination by using a beacon signal in the mobile device 1 according to the embodiment. START in FIG. 8 is a time point at which the determination application Ap is activated in the mobile device 1. At this time point, the processor 10 starts making determinations on whether to give the return instruction to the image forming apparatus and whether to give the shift instruction to the image forming apparatus.

Here, the mobile device 1 (the determination application Ap) is in a state in which making a determination by using a beacon signal has been selected (set). Further, in the determination application Ap, the image forming apparatus is already registered as the target of determination. In other words, the ID information i1 included in the beacon signal transmitted from the transmitter 28 of the image forming apparatus as the target of determination is registered in the storage section 11 (see FIG. 6). The image forming apparatus registered as the target of determination is the determination target apparatus 2.

On receiving the beacon signal including the registered ID information i1, the processor 10 performs processing based on the determination application Ap. In a case where a plurality of pieces of ID information i1 are registered (that is, there are a plurality of determination target apparatuses 2), the flow chart of FIG. 8 may be executed with respect to each of the determination target apparatuses 2. Or, the flow chart of FIG. 8 may be executed with respect only to the nearest one of the determination target apparatuses 2. In the determination setting screen S1, a check box B1 is provided. When an operation of putting a checkmark in the check box B1 is performed, the processor 10 makes a determination with respect only to the nearest one of the determination target apparatuses 2. The touch panel 13 accepts the setting of whether to perform the processing of making a determination with respect only to the nearest one of the determination target apparatuses 2.

First, the processor 10 checks whether the beacon signal receiver 18 has received a beacon signal from the determination target apparatus 2 (Step #11). The checking in step #11 is performed in accordance with the transmission cycle of the beacon signal. When no beacon signal has been received from the determination target apparatus 2 (No in Step #11), the processor 10 determines that the mobile device 1 is currently located in the outside area A0 (Step #12). After Step #12, the flow returns to Step #11.

When the beacon signal has been received from the determination target apparatus 2 (Yes in Step #11), the processor 10 detects the area to which the own device (the mobile device 1) belongs based on the intensity of the beacon signal received by the beacon signal receiver 18 (Step #13). Specifically, the processor 10 detects in which of the first, second, and third areas A1, A2, and A3, centered on the determination target apparatus 2, the mobile device 1 is located.

The processor 10 makes a determination on whether to give the return instruction to the determination target apparatus 2 (Step #14). When it is possible to determine, based on a change of the current position, that the separation distance has decreased by a distance equal to or greater than a reference distance, which is determined in advance, while the mobile device 1 is moving at a speed equal to or greater than a reference speed, which is also determined in advance, the processor 10 determines to issue the return instruction. In a case of the mobile device 1 moving toward the determination target apparatus 2, the area changes from one area to another in a direction approaching the determination target apparatus 2. Further, the faster the mobile device 1 moves toward the determination target apparatus 2, the shorter the time becomes during which the mobile device 1 belongs to one area.

Thus, when the current position of the mobile device 1 has changed to a position in the second area A2 within a reference time T1, which has been determined in advance, after changing to a position in the third area A3, the processor 10 determines (interprets) that the separation distance has decreased by a distance equal to or greater than the reference distance while the mobile device 1 is moving at a speed equal to or greater than the reference speed. The separation distance is a distance between the determination target apparatus 2 and the mobile device 1 (the own device). Further, when the current position of the mobile device 1 has changed to a position in the first area A1 within the reference time T1 after changing to a position in the second area A2, the processor 10 determines (interprets) that the separation distance has decreased by a distance equal to or greater than the reference distance while the mobile device 1 is moving at a speed equal to or greater than the reference speed.

On determining to issue the return instruction (Yes in Step #15), the processor 10 makes the communication section 17 transmit the return instruction to the determination target apparatus 2 (Step #16). Then, the flow returns to Step #11.

A widely used example of the mobile device 1 is a smart phone. Each user holds a mobile device 1. When a user (holder) moves, the mobile device 1 held by the holder also moves with the holder. To use a determination target apparatus 2, the holder moves toward the determination target apparatus 2. The separation distance is less likely to decrease in a case where the holder is not moving toward the determination target apparatus 2 than in a case where the holder is moving toward the determination target apparatus 2. Further, in a case where the holder is working at or near his or her desk, a travel distance over which the holder moves becomes short. Thus, the processor 10 of the mobile device 1 detects the current position based on the position detection signal. The processor 10 makes a determination on whether to give the determination target apparatus 2 the return instruction to return from the power saving mode to the active mode. When it is possible to determine, based on the change of the current position, that the separation distance, which is a distance between the determination target apparatus 2 and the own device, has decreased by a distance equal to or greater than the reference distance while the mobile device 1 is moving at a speed equal to or greater than the reference speed, the processor 10 determines to issue the return instruction. On determining to issue the return instruction, the processor 10 makes the communication section 17 transmit the return instruction. Thereby, it is possible to make a correct determination on whether the holder is moving toward the image forming apparatus (the determination target apparatus 2). It is possible for the mobile device 1 to give the return instruction to the determination target apparatus 2 while the mobile device 1 is yet on its way to the determination target apparatus 2. In other words, it is possible to make the determination target apparatus 2 start returning to the active mode before the holder reaches the determination target apparatus 2. Thereby, it is possible to eliminate or reduce waiting time for the holder to wait until the return to the active mode is completed. The holder can use the determination target apparatus 2 as soon as he or she reaches the determination target apparatus 2.

In a case where the holder is moving toward the image forming apparatus, the area changes from one to another at short time intervals in the direction toward the image forming apparatus. In the case where the holder is not moving toward the image forming apparatus, the area may change from one to another at long time intervals. To cope with such a case, the communication section 17 includes the first receiver (the beacon signal receiver 18), which receives the beacon signal from the transmitter 28 provided in the determination target apparatus 2. Based on the intensity of the beacon signal received by the first receiver, the processor 10 detects in which of the first area A1, the second area A2, the third area A3, and the outside area A0, which are centered on the determination target apparatus 2, the own device is located. When the area changes in the direction toward the determination target apparatus 2 within the reference time T1, the processor 10 determines (interprets) that the separation distance has decreased by a distance equal to or greater than the reference distance while the own device is moving at a speed equal to or greater than the reference speed. Thereby, in a case where the determination target apparatus 2 transmits an approach detection signal as the position detection signal, it is possible to make a correct determination on whether the holder is moving toward the determination target apparatus 2. It is possible for the mobile device 1 to give the return instruction to the determination target apparatus 2 when the mobile device 1 is yet on its way to the determination target apparatus 2. Thus, it is possible to make the determination target apparatus 2 start returning to the active mode before the holder reaches the determination target apparatus 2. It is possible to eliminate or reduce waiting time for the holder to wait until the return to the active mode is completed.

On determining not to issue the return instruction (No in Step #15), the processor 10 makes a determination on whether to give the shift instruction to the determination target apparatus 2 (Step #17). When it is possible to determine, based on the change of the current position, that the separation distance has increased by a distance equal to or greater than the reference distance while the mobile device 1 is moving at a speed equal to or greater than the reference speed, the processor 10 determines to issue the shift instruction.

In a case where the mobile device 1 is moving away from the determination target apparatus 2, the area changes from one to another in a direction away from the determination target apparatus 2. Further, the faster the mobile device 1 moves away from the determination target apparatus 2, the shorter the time becomes during which the mobile device 1 stays in one area. Thus, when the area in which the mobile device 1 is currently located changes to the second area A2 within the reference time T1 after changing to the first area A1, the processor 10 determines that the separation distance has increased by a distance equal to or greater than the reference distance while the mobile device 1 is moving at a speed equal to or greater than the reference speed. Further, when the area changes to the third area A3 within the reference time T1 after changing to the second area A2, the processor 10 determines that the separation distance has increased by a distance equal to or greater than the reference distance while the mobile device 1 is moving at a speed equal to or greater than the reference speed.

On determining to issue the shift instruction (Yes in Step #18), the processor 10 makes the communication section 17 transmit the shift instruction to the determination target apparatus 2 (Step #19). When the processor has determined not to issue the shift instruction (No in Step #18), and also after Step #19, the flow returns to Step #11.

When the holder finishes using the image forming apparatus, the holder moves away from the image forming apparatus. For example, he or she goes back to his or her desk. Then, the processor 10 makes a determination on whether to give the determination target apparatus 2 the shift instruction to shift from the active mode to the power saving mode. When it is possible to determine, based on the change of the current position, that the separation distance has increased by a distance equal to or greater than the reference distance while the mobile device 1 is moving at a speed equal to or greater than the reference speed, the processor 10 determines to issue the shift instruction. On determining to issue the shift instruction, the processor 10 makes the communication section 17 transmit the shift instruction to the determination target apparatus 2 (Step #19). Thereby, it is possible to make a correct determination on whether the holder is moving away from the determination target apparatus 2 after finishing using it. It is possible for the mobile device 1 to give the shift instruction to the determination target apparatus 2 as soon as the holder leaves the determination target apparatus 2. It is possible to make the determination target apparatus 2 shift to the power saving mode as soon as the holder finishes using it. No problem is caused even if the holder fails to perform the operation of shifting the determination target apparatus 2 to the power saving mode. Accordingly, it is possible to minimize wasteful power consumption in the determination target apparatus 2.

In a case where the holder is moving away from the determination target apparatus 2, the area changes from one to another in the direction away from the determination target apparatus 2 at reduced time intervals. Thus, when the area changes from one to another in the direction away from the determination target apparatus 2 within the reference time T1, the processor 10 determines (interprets) that the separation distance has increased by a distance equal to or greater than the reference distance while the mobile device 1 is moving at a speed equal to or greater than the reference speed. The processor 10 makes the communication section 17 transmit, to the determination target apparatus 2, the shift instruction to shift from the active mode to the power saving mode. Thereby, it is possible to make a correct determination on whether the holder is moving away from the determination target apparatus 2 after finishing using it. It is possible for the mobile device 1 to give the shift instruction to the determination target apparatus 2 as soon as the holder leaves the determination target apparatus 2. It is possible to make the determination target apparatus 2 shift to the power saving mode as soon as the holder finishes using it. It is possible to minimize wasteful power consumption in the determination target apparatus 2.

Here, different holders of the mobile device 1 move at different speeds. For example, people of higher ages tend to walk at lower speeds. People whose legs are hurt also walk slowly. To cope with such cases, in the mobile device 1 (the determination application Ap) is configured such that it is possible to set the reference time T1. The processor 10 displays the set reference time T1 in the determination setting screen S1. In the determination setting screen S1, a plus key K5 and a minus key K6, which are used to set the reference time T1, are provided (see FIG. 7). When the plus key K5 or the minus key K6 is operated, the processor 10 accordingly changes the length of the reference time T1. That is, the operation section (the touch panel 13) accepts the setting of the reference time T1. The storage section 11 stores therein the set reference time T1. The processor 10 makes a determination by using the reference time T1 stored in the storage section 11. Thereby, it is possible to set the reference time T1 to be suitable for the holder. For example, it is possible to set the reference time T1 to be somewhat long for a holder who is disabled in walking. It is possible to set the reference time T1 in accordance with the moving speed of each holder and to make a correct determination on whether each holder is moving toward or away from the determination target apparatus 2.

Determination Using GPS Signal:

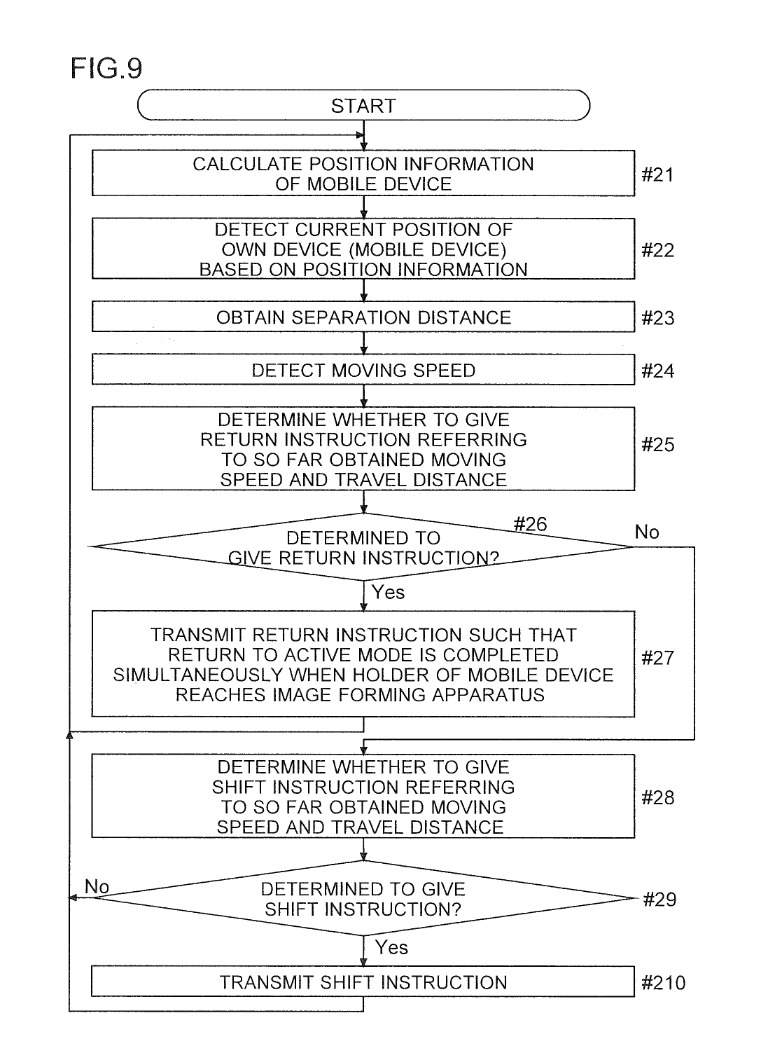

Next, by using FIG. 9, a description will be given of an example of the flow of making a determination by using a GPS signal in the mobile device 1 according to the embodiment. START in FIG. 9 is a time point at which the determination application Ap is activated in the mobile device 1. The mobile device 1 is set to use the GPS. At this time point, the processor 10 starts making determinations on whether to give the return instruction to the determination target apparatus 2 and whether to give the shift instruction to the determination target apparatus 2. Here, the mobile device 1 (the determination application Ap) is in a state in which making a determination by using a GPS signal has been selected (set). Further, in the determination application Ap, a pair of target coordinates Z1, which are coordinate values (indicating the position) of the determination target apparatus 2 as a target determination, have been already registered (see FIG. 6). In a case where a determination is made by using a GPS signal, the determination target apparatus 2 is an image forming apparatus whose position has been registered.

In a case where there are registered a plurality of pairs of target coordinates Z1, indicating positions of a plurality of determination target apparatuses 2, the flow chart of FIG. 9 may be executed with respect to each of the plurality of determination target apparatuses 2. Or, the flow chart of FIG. 9 may be executed with respect only to the nearest one of the plurality of determination target apparatuses 2. In a case where an operation of putting a checkmark in the check box B1 is performed (see FIG. 7), the processor 10 makes a determination with respect only to the nearest one of the determination target apparatuses 2.

The GPS signal receiver 19 calculates the position information (coordinates) of the mobile device 1 (Step #21). The processor 10 detects the current position of the own device (the mobile device 1) based on the position information notified by the GPS signal receiver 19 (Step #22). The processor 10 calculates a separation distance L1 (a distance between the determination target apparatus 2 and the mobile device 1) based on the position (the target coordinates Z1) of the determination target apparatus 2 and the current position of the mobile device 1 (Step #23) detected this time. The processor 10 sequentially stores, in the storage section 11, values of the separation distance L1 calculated at various time points.

The processor 10 detects a moving speed V1 of the own device (Step #24). For example, the processor 10 measures a time interval between the current-position-detection time point of this time and the current-position-detection time point of the previous time. The processor 10 obtains a travel distance from the current position detected at the previous time to the current position detected this time. The processor 10 divides the obtained travel distance by the obtained time interval. Whenever the processor 10 detects the current position, the processor 10 obtains the moving speed V1. The processor 10 sequentially stores, in the storage section 11, values of the moving speed L1 obtained at various time points.

The processor 10 makes a determination on whether to give the return instruction to the determination target apparatus 2 (Step #25). At this time, the processor 10 refers to the values of the moving speed V1 and of the separation distance L1 which have been obtained and stored so far. When it is possible to determine, based on the change of the current position, that the separation distance L1 has decreased by a distance equal to or greater than the reference distance while the mobile device 1 is moving at a speed equal to or greater than the reference speed, the processor 10 determines to issue the return instruction. In the case where the determination is made based on a GPS signal, the reference speed and the reference distance are set in advance. The reference speed and the reference distance can be stored in the storage section 11. The reference speed can be determined based on a walking speed (for example, 2 to 3 m/second).

Different reference speeds and different reference distances may be set for different mobile devices 1. In such a case, the touch panel 13 of each mobile device 1 accepts the settings of the reference speed and the reference distance. The processor 10 stores the thus set reference speed and reference distance in the storage section 11. The processor 10 makes a determination based on the thus set reference speed and reference distance.

When the moving speed V1 (the newest moving speed V1) obtained in Step #24 is equal to or greater than the reference speed, the processor 10 obtains a total decrease amount of the separation distance L1 in a period from the current time back to the time point at which the moving speed V1 has started to be equal to or greater than the reference speed. When the absolute value of the total decrease amount is equal to or greater than the reference distance, the processor 10 determines to issue the return instruction. On determining to issue the return instruction (Yes in Step #26), the processor 10 makes the communication section 17 transmit the return instruction to the determination target apparatus 2 (Step #27). Then, the flow returns to Step #21.

Thus, when the separation distance L1 has decreased by a distance equal to or greater than the reference distance while the device is moving at a speed equal to or greater than the reference speed, the processor 10 determines to issue the return instruction. It is possible to detect a movement at a speed equal to or greater than the reference speed based on position detection performed by using a GPS signal. Also, it is possible to detect decrease of the separation distance L1 between the determination target apparatus 2 and the mobile device 1 by a distance equal to or greater than the reference distance. This makes it possible to make a correct determination on whether the holder is moving toward the determination target apparatus 2. It is possible for the mobile device 1 to give the return instruction to the determination target apparatus 2 while the holder is yet on his or her way to the determination target apparatus 2. This makes it possible to make the determination target apparatus 2 start returning to the active mode before the holder reaches the determination target apparatus 2. Thereby, it is possible to eliminate or reduce waiting time for the holder to wait until the return to the active mode is completed.

Here, different holders of the mobile device 1 move at different speeds. Further, desks of different holders are at different distances from the determination target apparatus 2. Thus, different holders take different lengths of time to reach the determination target apparatus 2 from the start of their movement toward the determination target apparatus 2. As the time between when the return to the active mode is completed and when the holder reaches the image forming apparatus becomes longer, the standby time of the image forming apparatus becomes longer. As the standby time becomes longer, more power is consumed wastefully. In order to avoid wasteful power consumption, it is preferred to reduce the time during which the image forming apparatus is not operated or used.

Hence, the processor 10 may make the communication section 17 transmit the return instruction to the determination target apparatus 2 such that the return to the active mode is completed simultaneously when the holder reaches the determination target apparatus 2. For example, the processor 10 obtains the average of the moving speed V1 in a time period during which the moving speed V1 has been equal to or greater than the reference speed. The processor 10 divides the separation distance L1 by the obtained average to estimate a necessary time. The estimated necessary time is an estimated length of time that it will take the holder to reach the determination target apparatus 2 from his or her current position. On the other hand, a time (a return time T2) necessary for the image forming apparatus (the determination target apparatus 2) to return to the active mode is determined in the specifications of the image forming apparatus. The return time T2 is registered in advance in the storage section 11 (the determination application Ap). When a result obtained by subtracting the estimated necessary time from the return time T2 is smaller than an allowable value C1, the processor 10 makes the communication section 17 transmit the return instruction. The return time T2 and the allowable value C1 are determined in advance. The return time T2 and the allowable value C1 are stored in the storage section 11. The allowable value C1 is several seconds, for example. Thereby, it is possible to issue the return instruction such that the return to the active mode is competed simultaneously when the holder reaches the determination target apparatus 2. Thus, it is possible to reduce wasteful consumption of power.

On determining not to issue the return instruction (No in Step #26), the processor 10 makes a determination on whether to give the shift instruction to the determination target apparatus 2 (Step #28). The processor 10 refers to the values of the moving speed V1 and the travel distance which have been obtained and stored so far. When it is possible to determine, based on the change of the current position, that the separation distance L1 has increased by a distance equal to or greater than the reference distance while the mobile device 1 is moving at a speed equal to or greater than the reference speed, the processor 10 determines to issue the shift instruction. Specifically, when the moving speed V1 (the latest obtained moving speed V1) obtained in Step #24 is equal to or greater than the reference speed, the processor 10 obtains the total increase amount of the separation distance L1 in a period from the current time back to the time point at which the moving speed V1 has started to be equal to or greater than the reference speed. When the total increase amount is equal to or greater than the reference distance, the processor 10 determines to issue the shift instruction.

On determining to issue the shift instruction (Yes in Step #29), the processor 10 makes the communication section 17 transmit the shift instruction to the determination target apparatus 2 (Step #210). When the processor has determined not to issue the shift instruction (No in Step #29), and also after Step #210, the flow returns to Step #21.

When the separation distance L1 has increased by a distance equal to or greater than the reference distance while the mobile device 1 is moving at a speed equal to or greater than the reference speed, the processor 10 determines to issue the shift instruction to shift from the active mode to the power saving mode, and makes the communication section 17 transmit the shift instruction to the determination target apparatus 2. Thereby, it is possible to make a correct determination, based on position detection performed by using a GPS signal, on whether the holder is moving away from the determination target apparatus 2 after finishing using it. It is possible for the mobile device 1 to give the shift instruction to the determination target apparatus 2 as soon as the holder leaves the determination target apparatus 2. It is possible to make the determination target apparatus 2 shift to the power saving mode as soon as the holder finishes using it. Accordingly, it is possible to minimize wasteful power consumption in the determination target apparatus 2.

Shift Notification Based on Job Termination Notification:

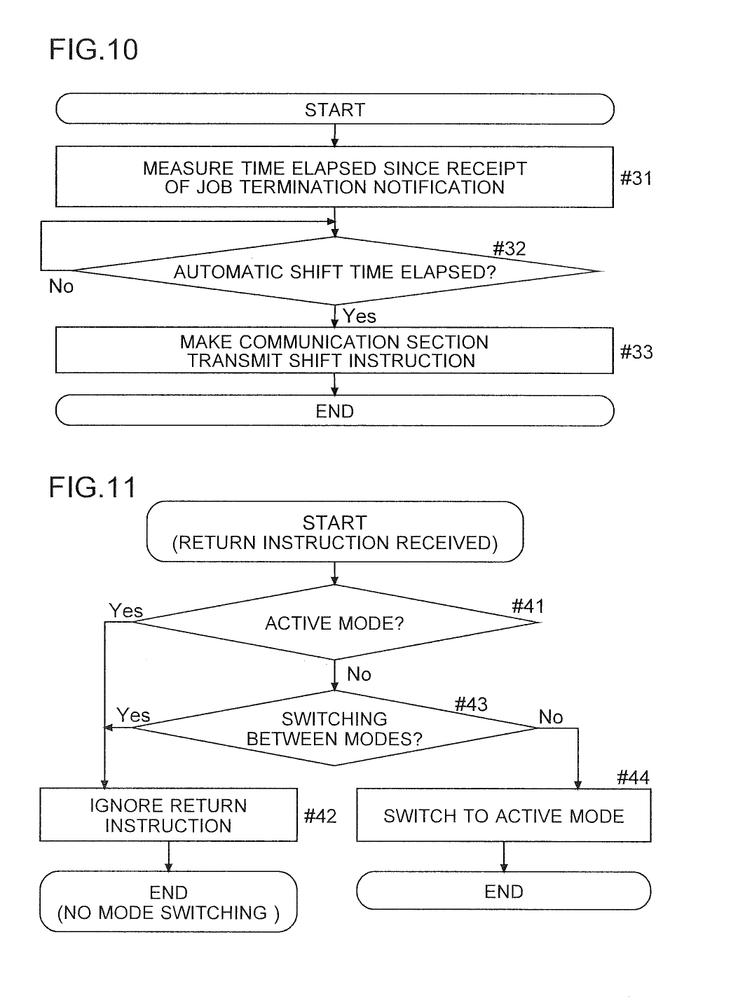

Next, by using FIG. 10, a description will be given of an example of the flow of shift notification based on a job termination notification in the mobile device 1 according to the embodiment. There is a case where the desk of the holder is near the determination target apparatus 2. In such a case, the travel distance of the holder from the determination target apparatus 2 to his or her desk is so short that the holder may reach his or her desk, without the mobile device 1 issuing the shift instruction at all. This may result in a case where the determination target apparatus 2 is left in the active mode without being used. That is, in a case where the desk of a user is close to the determination target apparatus 2, no shift instruction based on the position detection performed by using a position detection signal (such as a beacon signal and a GPS signal) may be issued.

START in FIG. 10 is a time point at which the communication section 17 (the wireless communication unit 17a) receives a job termination notification from the determination target apparatus 2. When a job is terminated, the controller 21 of the determination target apparatus 2 makes the wireless communication section 27 transmit a job termination notification. The wireless communication unit 17a of the mobile device 1 receives the job termination notification. Here, the processor 10 has determined that the desk of the holder is in the vicinity area by the time when the job termination notification is received.

First, the processor 10 measures the time elapsed since the receipt of the job termination notification (Step p31). Then, the processor 10 continues checking whether an automatic shift time, which is determined in advance, has elapsed since the receipt of the job termination notification (Step #32, No in Step #32 to Step #32). The automatic shift time is properly determined. The automatic shift time is stored in the storage section 11. It should be avoided that the determination target apparatus 2 is left in the active mode for a long time. Hence, the automatic shift time may be set to several tens of seconds, or may be set to several minutes.

When the automatic shift time has elapsed (Yes in Step #32), the processor 10 makes the communication section 17 transmit, to the determination target apparatus 2, the shift instruction to shift from the active mode to the power saving mode (Step #33 END). Thereby, it is possible to make the determination target apparatus 2, left in the active mode after being used, shift to the power saving mode. Thereby, even in a case where the desk of the holder is near the determination target apparatus 2, it is possible to automatically and securely shift the determination target apparatus 2 to the power saving mode after being used.

Processing by Determination Target Apparatus 2 on Receiving Return Instruction:

Next, by using FIG. 11, a description will be given of an example of the flow of processing performed when the determination target apparatus 2 according to the embodiment has received the return instruction. START in FIG. 11 is a time point at which the determination target apparatus 2 receives the return instruction from the mobile device 1. First, the controller 21 checks whether the current mode of the determination target apparatus 2 is the active mode (Step #41). When the determination target apparatus 2 is in the active mode, (Yes in step #41), the controller 21 ignores the return instruction (Step #42→END). When the flow has ended with Step #42, the mode of the determination target apparatus 2 is not switched.

On the other hand, when the determination target apparatus 2 is not in the active mode, (No in step #42), the controller 21 checks whether the determination target apparatus 2 is in the process of mode switching (Step #43). That is, the controller 21 checks whether the determination target apparatus 2 is in the process of shifting from the active mode to the power saving mode. The controller 21 also checks whether the determination target apparatus 2 is in the process of returning from the power saving mode to the active mode. Stopping the mode switching process midway could invite malfunction. To prevent such malfunction, when the determination target apparatus 2 is in the process of mode switching (Yes in Step #43), the controller 21 ignores the return instruction (Step #42→END).

When the determination target apparatus 2 is not in the process of mode switching (No in STEP #43), the controller 21 shifts the determination target apparatus 2 to the active mode (Step #44). Specifically, the controller 21 instructs the power supply controller 290 to shift to the active mode. In response to this instruction, the power supply controller 290 sequentially restarts power supply to the power supply restriction portion.

Processing by Determination Target Apparatus 2 on Receiving Shift Instruction:

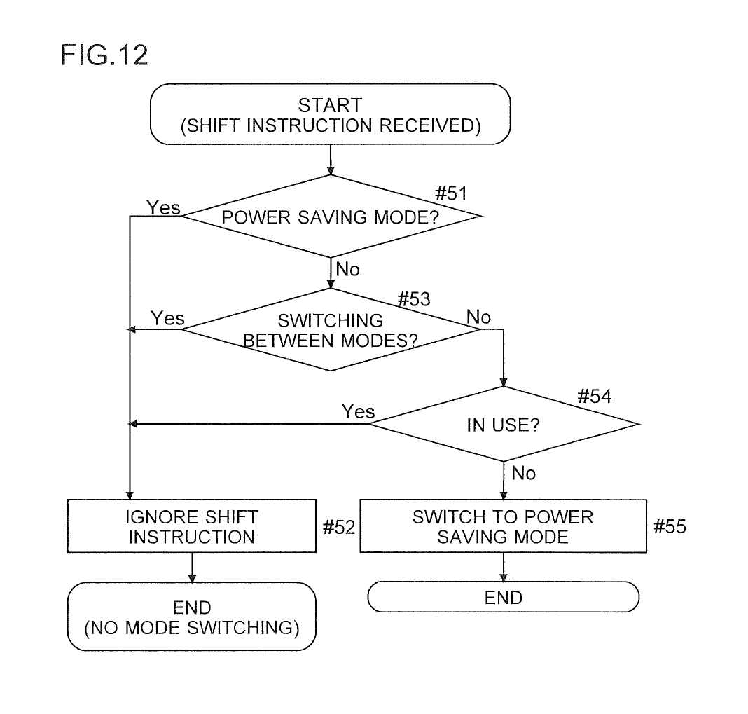

Next, by using FIG. 12, a description will be given of an example of the flow of processing performed when the determination target apparatus 2 according to the embodiment has received the shift instruction. START in FIG. 12 is a time point at which the determination target apparatus 2 receives the shift instruction from the mobile device 1. First, the controller 21 checks whether the current mode of the determination target apparatus 2 is the power saving mode (Step #51). When the determination target apparatus 2 is in the power saving mode (Yes in Step #51), the controller 21 ignores the shift instruction (Step #52→END). When the flow has ended with Step #52, the mode of the determination target apparatus 2 is not switched.

On the other hand, when the determination target apparatus 2 is not in the power saving mode, (No in step #51), the controller 21 checks whether the determination target apparatus 2 is in the process of mode switching (Step #53). In other words, the controller 21 checks whether the determination target apparatus 2 is in the process of shifting from the active mode to the power saving mode. The controller 21 also checks whether the determination target apparatus 2 is in the process of returning from the power saving mode to the active mode. That is, the controller 21 checks whether the determination target apparatus 2 is in a state where the mode shifting is not completed yet. Then, when the determination target apparatus 2 is in the process of mode switching (Yes in Step #53), the controller 21 ignores the shift instruction (Step #52→END).

When the determination target apparatus 2 is not in the process of mode switching (No in Step #53), the controller 21 makes a determination on whether the determination target apparatus 2 is being used (Step #54). When the determination target apparatus 2 is being used (Yes in Step #54), the controller 21 ignores the shift instruction (Step #52→END). It is not preferable for the determination target apparatus 2 to be shifted to the power saving mode during a job execution. The job would be terminated before completion. To prevent this, when a job is being executed, the controller 21 determines that the determination target apparatus 2 is being used. It is not preferable, either, for the determination target apparatus 2 to be shifted to the power saving mode while the operation panel 22 is being operated for setting. To prevent this, within a given time after the touch panel 13 or any of the hardware keys on the operation panel 22 is operated, the controller 21 determines that the determination target apparatus 2 is being used. The given time may be determined as appropriate. For example, the given time is set to any time from several seconds to several minutes.

When the determination target apparatus 2 is not being used (No in STEP #54), the controller 21 shifts the determination target apparatus 2 to the power saving mode (Step #55). Then, this flow ends (END). The controller 21 instructs the power supply controller 290 to shift to the power saving mode. In response to this instruction, the power supply controller 290 sequentially stops power supply to the power supply restriction portion.

An image forming system 100 includes the mobile device 1 described above and an image forming apparatus. In the image forming system 100, it is possible to make the determination target apparatus 2 start returning to the active mode when the holder of the mobile device 1 is still on his or her way to the determination target apparatus 2. It is possible to eliminate or reduce waiting time for the holder to wait until the return to the active mode is completed.

The embodiments of the present disclosure described herein are not meant to limit the scope of the present disclosure in any manner. The present disclosure may be implemented by making various modifications thereto without departing from the spirit of the present disclosure.

What is claimed is:

1. A mobile device, comprising:
an operation section which accepts a setting;
a storage section which stores data therein;
a communication section which receives a position detection signal for obtaining a current position of the mobile device; and
a processor which
detects the current position based on the position detection signal,
makes a determination on whether to give a determination target apparatus, which is an image forming apparatus set as a target of determination, a return instruction to return from a power saving mode to an active mode,
determines to issue the return instruction when it is possible to determine, based on a change of the current position, that a separation distance, which is a distance between the determination target apparatus and the mobile device, has decreased by a distance equal to or greater than a reference distance while a moving speed of the mobile device is equal to or greater than a reference speed, the reference distance and the reference speed being determined in advance, and
makes the communication section transmit the return instruction on determining to issue the return instruction.

2. The mobile device according to claim 1,
wherein
the processor
makes a determination on whether to give the determination target apparatus a shift instruction to shift from the active mode to the power saving mode,
determines to issue the shift instruction when it is possible to determine, based on the change of the current position, that the separation distance has increased by a distance equal to or greater than the reference distance while the moving speed is equal to or greater than the reference speed, and
makes the communication section transmit the shift instruction to the determination target apparatus on determining to issue the shift instruction.

3. The mobile device according to claim 1,
wherein
the communication section includes a first receiver which receives a beacon signal from a transmitter provided in the determination target apparatus,
the processor detects, based on intensity of the beacon signal received by the first receiver, in which of a first area, a second area, a third area, and an outside area the mobile device is located, the first area, the second area, the third area, and the outside area being centered on the determination target apparatus,
the first area is an area nearest to the determination target apparatus,
the second area is an area farther from the determination target apparatus than the first area is,
the third area is an area farther from the determination target apparatus than the second area is,
the outside area is outside all of the first area, the second area, and the third area, and
when the current position has changed to a position in the second area within a reference time, which is determined in advance, after changing to a position in the third area, or when the current position has changed to a position in the first area within the reference time after changing to a position in the second area, the processor determines that the separation distance has decreased by a distance equal to or greater than the reference distance while the moving speed is equal to or greater than the reference speed.

4. The mobile device according to claim 3,
wherein
the processor
determines that the separation distance has increased by a distance equal to or greater than the reference distance while the moving speed is equal to or greater than the reference speed
when the current position has changed to a position in the second area within the reference time after changing to a position in the first area, or
when the current position has changed to a position in the third area within the reference time after changing to a position in the second area, and
makes the communication section transmit, to the determination target apparatus, a shift instruction to shift from the active mode to the power saving mode.

5. The mobile device according to claim 3,
wherein
the operation section accepts a setting of the reference time,
the storage section stores therein the reference time which has been set, and
the processor uses the reference time stored in the storage section.

6. The mobile device according to claim 1,
wherein
the communication section includes a second receiver which receives a GPS signal, and
the processor
detects the current position based on the GPS signal received by the second receiver,
detects the moving speed based on a change of the current position which has been detected, and
determines to issue the return instruction when the separation distance has decreased by a distance equal to or greater than the reference distance while the moving speed is equal to or greater than the reference speed.

7. The mobile device according to claim 6,
wherein
the processor
detects the current position based on the GPS signal received by the second receiver,
detects the moving speed based on a change of the current position which has been detected,
determines to issue a shift instruction to shift from the active mode to the power saving mode when the separation distance has increased by a distance equal to or greater than the reference distance while the moving speed is equal to or greater than the reference speed, and
makes the communication section transmit the shift instruction to the determination target apparatus on determining to issue the shift instruction.

8. The mobile device according to claim 6,
wherein
the processor
obtains an average of the moving speed detected in a time period during which the moving speed has been equal to or greater than the reference speed,
obtains an estimated necessary time by dividing the separation distance by the average, and
makes the communication section transmit the return instruction when a difference between a return time, which is determined in advance as a time necessary for the determination target apparatus to return to the active mode, and the estimated necessary time becomes smaller than an allowable value, which is determined in advance.

9. The mobile device according to claim 1,
wherein
the communication section receives a job termination notification from the determination target apparatus, and
the processor makes the communication section transmit, to the determination target apparatus, a shift instruction to shift from the active mode to the power saving mode when an automatic shift time, which is determined in advance, has elapsed after the job termination notification is received.

10. An image forming system comprising:
the mobile device according to claim 1; and
the determination target apparatus, which is an image forming apparatus that performs shifting to the power saving mode and returning to the active mode based on instructions from the mobile device.

11. The image forming system according to claim 10,
wherein
the determination target apparatus includes a controller which controls an operation of the determination target apparatus,
when the return instruction is received,
the controller,
checks whether the determination target apparatus is in a process of mode switching, and
ignores the return instruction when the determination target apparatus is in the process of mode switching, and
when the shift instruction is received,
the controller
checks whether the determination target apparatus is in the process of mode switching, and
ignores the shift instruction when the determination target apparatus is in the process of mode switching.

12. A method for controlling a mobile device, comprising:
receiving a position detection signal for obtaining a current position of a mobile device;
detecting the current position based on the position detection signal;
making a determination on whether to give a determination target apparatus, which is an image forming apparatus set as a target of determination, a return instruction to return from a power saving mode to an active mode;
determining to issue the return instruction when, based on a change of the current position, it is possible to determine that a separation distance, which is a distance between the determination target apparatus and the mobile device, has decreased by a distance equal to or greater than a reference distance while a moving speed of the mobile device is equal to or greater than a reference speed, the reference distance and the reference speed being determined in advance; and
transmitting the return instruction to the determination target apparatus on determining to issue the return instruction.
